(19) United States
(12) Patent Application Publication
(10) Pub. No.: US 2025/0222903 A1
(43) Pub. Date: Jul. 10, 2025

(54) VEHICLE CLEANING SYSTEM

(71) Applicant: Unger Marketing International, LLC, Bridgeport, CT (US)

(72) Inventors: James M. Buckley, New Hartford, CT (US); Audrey McMahon, Kokomo, IN (US); Joseph K. Patterson, Monroe, CT (US); William Harrington, Newtown, CT (US); Stephen P. Huda, Shelton, CT (US); Brandon M. Temple, Stamford, CT (US)

(21) Appl. No.: 19/009,340

(22) Filed: Jan. 3, 2025

Related U.S. Application Data
(60) Provisional application No. 63/617,833, filed on Jan. 5, 2024.

(51) Int. Cl. B60S 3/04; B62B 3/00

(52) U.S. Cl. CPC B60S 3/045; B62B 3/001; B62B 3/005; B62B 2202/50

(57) ABSTRACT

A cleaning system is provided that includes a trolley, a bucket assembly, a tray member, and a pole. In an embodiment, the bucket assembly comprises a bucket, a handle rotatably coupled to the bucket, a cover adapted to engage an open end of the bucket, and a kneeling pad. The bucket includes a plurality of walls having a first and second end walls. The trolley includes a first area where the bucket assembly may be stored, a second area, and a plurality of wheels. The pole extends from the trolley system. The cleaning system is moved on the plurality of wheels and manipulation of the pole.

### CROSS-REFERENCE TO RELATED APPLICATIONS

The present application claims the benefit of, and is a nonprovisional application of, U.S. Provisional Application Ser. No. 63/617,833, filed Jan. 5, 2024, the contents of which are incorporated by reference herein in its entirety.

### BACKGROUND OF THE DISCLOSURE

The subject matter disclosed herein relates to cleaning bucket-system, and in particular to a cleaning or washing bucket-system for a vehicle such as an automobile.

The cleaning of a vehicle often requires a number of tools and a certain volume of water. Typically, the user has a wash buck that includes water and a cleaning solution. The user hand carries the bucket to the vehicle. The tools may include sponges and brushes that the user also hand carries to the vehicle. In order to utilize the cleaning system, the bucket is filled with a cleaning fluid and carries it to the location to be cleaned. The user dips the cleaning tool, such as a sponge or brush, into the fluid contained in the bucket. The cleaning tool is fully wetted in the fluid. The cleaning tool is then lifted out of the bucket and set onto a surface and used to clean until the cleaning tool becomes dirty, at which point the process is repeated. Often, multiple tools are used and as a result, the unused tools are left on the ground while the user cleans the vehicle with a different tool, resulting in them getting dirty. Additionally, the user typically must crouch down and kneel to clean low clearance areas of the vehicle, resulting in uncomfortable positions and kneeling on hard pavement. A third issue that arises with current cleaning systems is the amount of dirt and debris collected in the cleaning tool and released in the bucket when placed in the cleaning fluid contained in the bucket.

Accordingly, while existing cleaning systems are suitable for their intended purposes the need for improvement remains, particularly in providing a cleaning or washing system having the features described herein.

### BRIEF DESCRIPTION OF THE DISCLOSURE

According to one aspect of the disclosure a cleaning system is provided having a trolley having a first area, a second area adjacent to the first area, and a plurality of wheels depending from an undersurface of the trolley, a tray member extending from the trolley, a bucket assembly selectively stored on the trolley, and a pole extending from a first end of the trolley. The pole has a handle extending therefrom. The first area sized to receive a bucket.

In addition to one or more of the features described herein, or as an alternative, in further embodiments the first area and the second area are recessed within a frame of the trolley and the first area is separated by the second area by a wall. The recessed second area may receive and store cleaning supplies.

In addition to one or more of the features described herein, or as an alternative, in further embodiments the second area further comprising at least one cavity configured to receive at least one leg of the tray member, wherein the cavity is adjacent to the wall. In an embodiment, the second area comprises a first cavity positioned at the first end of the trolley and adjacent to the wall and a second cavity positioned at a second end of the trolley and adjacent to the wall.

In addition to one or more of the features described herein, or as an alternative, in further embodiments the first area includes a bottom surface having a grid pattern and the second area includes a bottom surface having a plurality of holes.

In addition to one or more of the features described herein, or as an alternative, in further embodiments the first area further comprising at least one slot formed in a corner of the first area on the frame or the wall, wherein the slot is configured to engage the bucket. In an embodiment, the first area comprises four slots formed in four corners of the first area.

In addition to one or more of the features described herein, or as an alternative, in further embodiments the first area further comprising the at least one mating pin extending from a bottom surface of the first area in a corner of the first area to align the bucket in the first area. In an embodiment, the first area comprises four mating pins extending from the bottom surface in the four corners of the first area.

In addition to one or more of the features described herein, or as an alternative, in further embodiments at least one wheel of the plurality of wheels includes a lock configured to engage the at least one wheel and prevent rotation thereof, thereby inhibiting movement of the trolley.

In addition to one or more of the features described herein, or as an alternative, in further embodiments the bucket assembly further comprises a bucket having a base, an open top, and a plurality of walls defining an interior area, a handle having a center portion with a pair of opposing arms, the handle rotatably coupled to the bucket, a grit member removably positioned within the interior area, a cover configured to engage the plurality of walls on a top edge, and a kneeling pad selectively stored on the cover.

In addition to one or more of the features described herein, or as an alternative, in further embodiments the bucket further comprises at least one foot extending from a bottom end of a corner defined by two walls of the plurality of walls and at least one mating pin extending from a bottom surface of the base in a corner of the bucket. The at least one mating pin of the bucket is configured to mate with at least one mating pin of the first area. In an embodiment, the bucket comprises four feet extending from four corners of the bucket and four mating pins extend from the bottom surface of the base in the four corners of the bucket.

In addition to one or more of the features described herein, or as an alternative, in further embodiments the cover further comprises a first side, a second side opposing the first side, a first end disposed between the first and second side, and a second end opposing the first end. In an embodiment the cover comprises a first tab and a second tab, the first tab and second tab opposing one another and a ridge formed along the first side, second end, and second side. A cover has a cover portion sized to engage the plurality of walls on a top edge.

In addition to one or more of the features described herein, or as an alternative, in further embodiments the kneeling pad is dimensioned to fit in an area defined by the ridge and abut the ridge. The kneeling pad is dimensioned to be stored on the cover.

In addition to one or more of the features described herein, or as an alternative, in further embodiments the grit member is substantially planar and includes a plurality of holes extending therethrough. The grit member is sized to fit in the interior area of the bucket.

In addition to one or more of the features described herein, or as an alternative, in further embodiments the tray member further comprises at least one recessed area having a plurality of holes extending therethrough, at least one opening, and at least one leg having a first portion coupled to the second area of the trolley and a second portion coupled to the tray member. The first portion of the at least one leg is inserted into at least one cavity of the second area and the second portion of the at least one leg is oriented away from the trolley, thereby offsetting the tray member from the trolley. The plurality of holes of the at least one recessed area allows fluids to drain therethrough. The at least one opening is sized to receive the handles of cleaning tools.

In addition to one or more of the features described herein, or as an alternative, in further embodiments the cleaning system further comprises a bracket coupled to the pole, the bracket comprising at least one clip configured to hold cleaning tools and a hose or hose sprayer and at least one hook configured to hold cleaning cloths or rags.

According to one aspect of the disclosure a method for using a cleaning system is provided. The method comprises filling an interior area of a bucket with a cleaning fluid, inserting a cleaning tool in the interior area to wet the cleaning tool, cleaning a surface with the cleaning tool, reinserting the cleaning tool in the interior area, scrubbing the cleaning tool against the grit member to remove contaminates from the cleaning tool, and removing the cleaning tool from the interior area. The bucket comprises a base, an open top, and a plurality of walls defining the interior area, a handle having a center portion with a pair of opposing arms, the handle rotatably coupled to the bucket, and a grit member removably positioned in the interior area.

Technical effects of embodiments of the present disclosure include a cleaning bucket-system that allows an object, such as a vehicle, to be cleaned while reducing or eliminating user strain and excess contamination of cleaning tools, and providing storage and transportability of cleaning tools.

These and other advantages and features will become more apparent from the following description taken in conjunction with the drawings.

### BRIEF DESCRIPTION OF DRAWINGS

The subject matter, which is regarded as the disclosure, is particularly pointed out and distinctly claimed in the claims at the conclusion of the specification. The foregoing and other features, and advantages of the disclosure are apparent from the following detailed description taken in conjunction with the accompanying drawings in which:

FIG. 1 is a perspective view of the cleaning system in accordance with an embodiment;

FIG. 2 is a perspective view of the cleaning system with the kneeling pad removed in accordance with an embodiment;

FIG. 3 is a perspective view of the cleaning system with the cover and kneeling pad removed in accordance with an embodiment;

FIG. 4 is an unassembled view of the cleaning system in accordance with an embodiment;

FIG. 5 is a perspective view of the cleaning system with the bucket assembly removed in accordance with an embodiment;

FIG. 6 is a bottom view of the cleaning system in accordance with an embodiment;

FIG. 7 is a perspective view of the cleaning system with the bucket assembly and pole removed in accordance with an embodiment;

FIGS. 8-9 are a perspective views of a bucket assembly of the cleaning system in accordance with an embodiment;

FIG. 10 is a top view of the cleaning system with the cover and kneeling pad removed in accordance with an embodiment; and

FIG. 11 is a perspective view of a pole of the cleaning system in accordance with an embodiment.

The detailed description explains embodiments of the disclosure, together with advantages and features, by way of example with reference to the drawings.

### DETAILED DESCRIPTION OF THE DISCLOSURE

Embodiments of the present disclosure provide for a cleaning system as described herein that allow a user to conveniently transport, store, and organize cleaning supplies for use with cleaning an object, such as a vehicle or automobile. Embodiments of the present disclosure include advantages in keeping all of the user's cleaning tools, bucket, and hose organized. Embodiments of the present disclosure include advantages in moving all the user's vehicle cleaning tools around the vehicle with less effort. Embodiments of the present disclosure include advantages in providing an integrated kneeling pad to reduce strain on the user's joints when cleaning low areas of their vehicle. Embodiments of the present disclosure include advantages in avoiding scratches by having a grit guard to trapping or isolating dirt and debris at bottom of bucket. Embodiments of the present disclosure include advantages in organizing and storing the user's tools when not in use. Embodiments of the present disclosure include advantages in allowing the user to sit on top of the closed lid while cleaning or drying low areas of the vehicle. Embodiments of the present disclosure include advantages in having the accessories tray and sponge holder to facilitate air drying when the user is finished cleaning. Embodiments of the present disclosure include advantages in not needing to leave the hose and tools on the ground while the user is cleaning the car. Finally, embodiments of the present disclosure include advantages in using the cleaning system for other tasks around the house or yard.

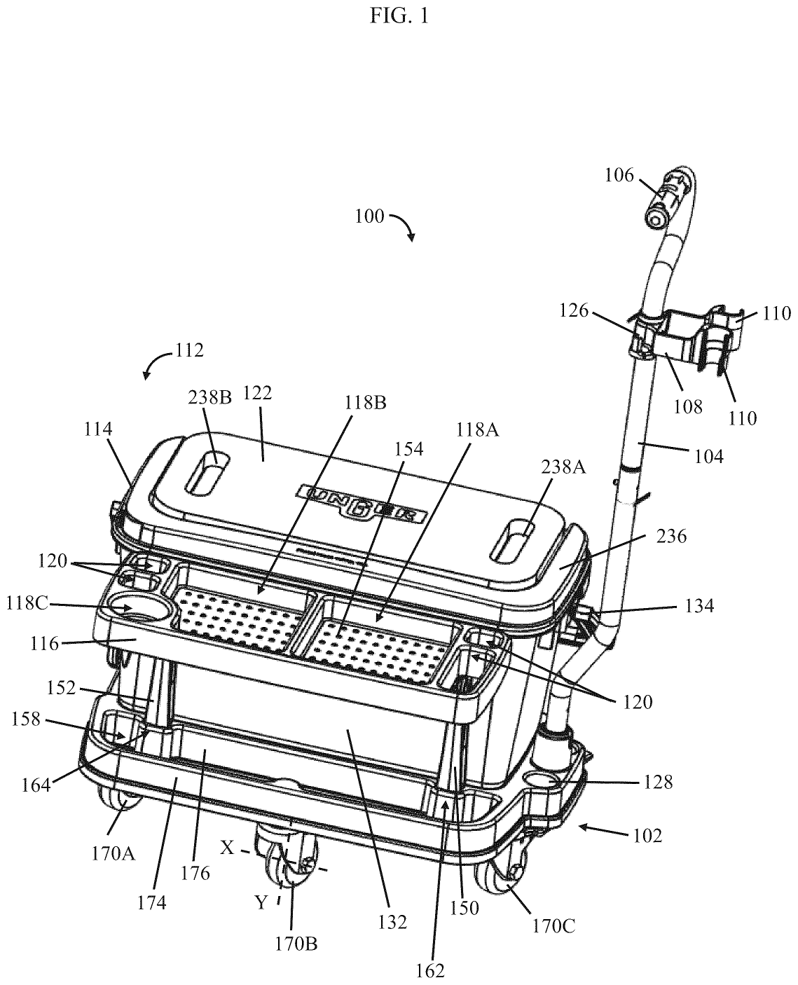

Referring to the drawings and in particular to FIGS. 1-3, a cleaning system 100, according to the present disclosure is shown.

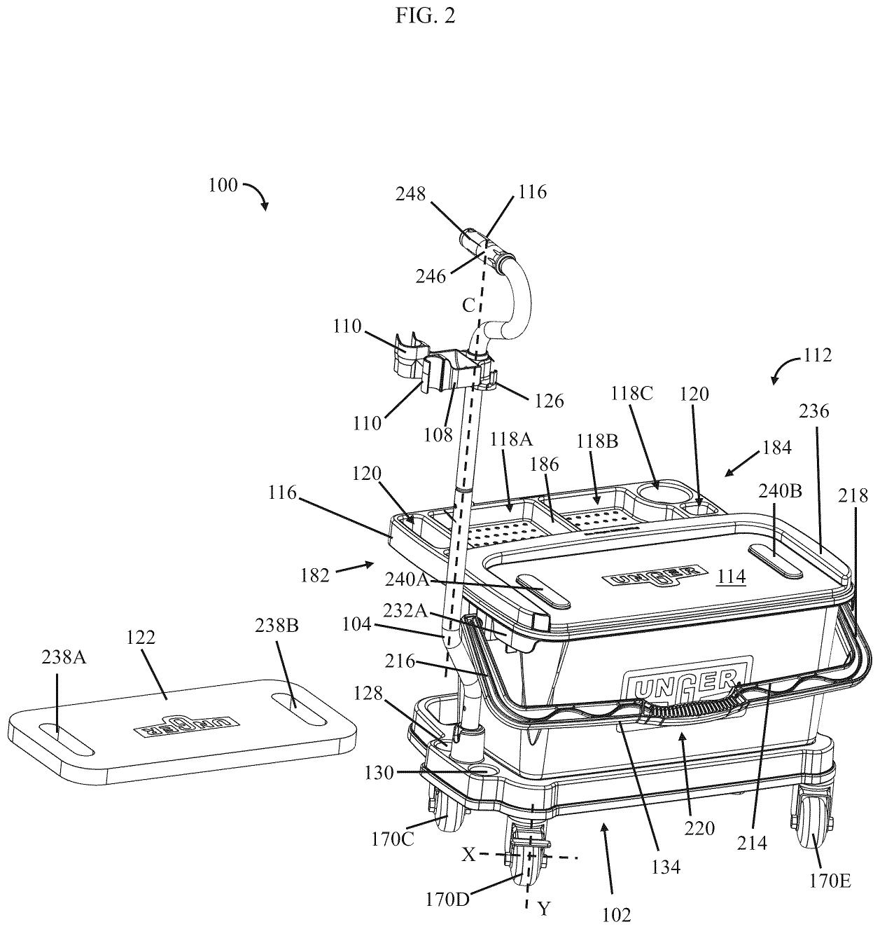

The cleaning system 100 may include a trolley 102 having a pole 104 extending therefrom, and a bucket assembly 112 and a tray member 116. Both the bucket assembly 112 and tray member 116 may fixedly coupled, integrated formed with, or removably attached to the trolley 102. The pole 104 has a handle 106 extending therefrom. The handle 106 may extend from the pole 104 perpendicular to a central axis C of the pole 104 (FIG. 2), such that it is parallel to the trolley 102. The cleaning system 100 may include a bracket 108 adapted to be coupled to the pole 104, the bracket 108 having at least one clip 110 configured to hold cleaning tools, a hose, a hose sprayer, or the like. The bracket 108 may further include at least one hook 126 for hanging cloths, rags, or the like. In the illustrated, non-limiting embodiment, the bracket includes two clips 110 and two hooks 126. The trolley 102 may include pockets or holes 128, 130 configured to hold cleaning tools, for example, including but not limited to, a mop, broom, or squeegee. The holes 128, 130 may be formed in the trolley 102 on either side of the pole 104.

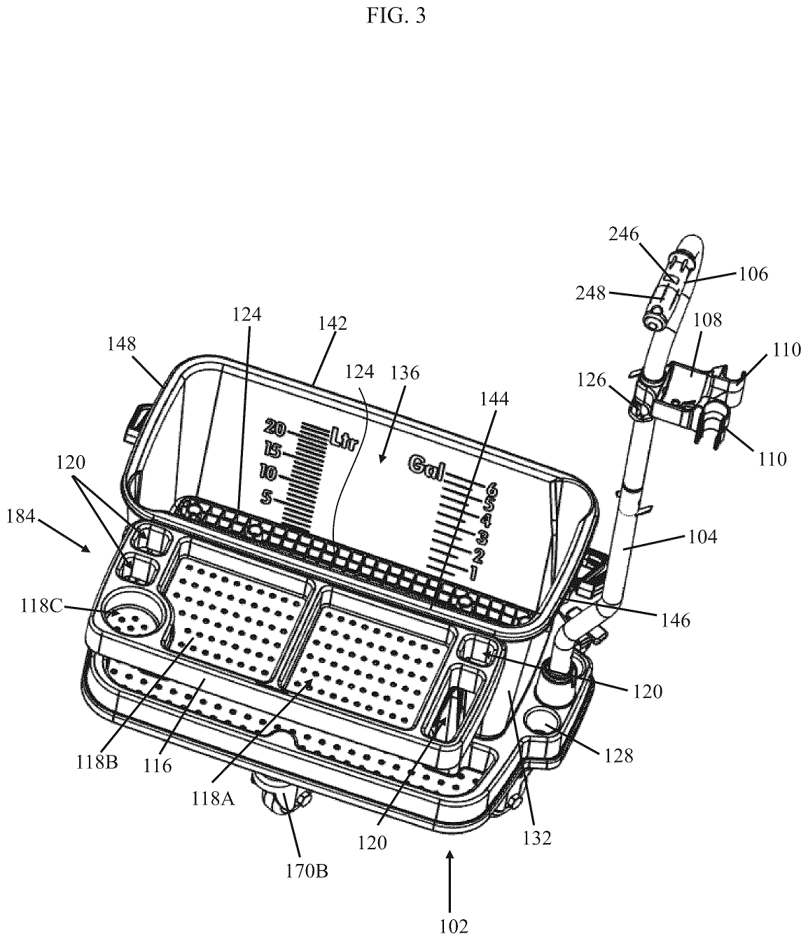

The bucket assembly 112, described further below, may include a bucket 132, a cover 114, a kneeling pad 122, and a handle 134. The bucket 132 is provided having a plurality of walls that form an interior area 136. A cover 114 is provided having a cover portion sized to engage the plurality of walls on a top edge 222. The kneeling pad 122 is dimensioned to be stored on the cover 114 and may be made from a soft material, such as a closed or open cell foam for example. The kneeling pad 122 may be removed from the bucket assembly 112 and placed on the ground (FIG. 2) for the user to kneel or sit on, by way of example. The handle 134 is rotatably coupled to two opposing walls of the bucket 132 to allow the user to carry the bucket 132 separate from the trolley. As shown in FIG. 3, the kneeling pad 122 and cover 114 may be removed to expose an open top 140 of the bucket. The bucket assembly 112 may further include a grate. grill, or grit member 124 sized to fit in the interior area 136 and be positioned on a base 138 of the bucket 132. The grit member 124 may be generally planar and having a plurality of holes extending therethrough. In an embodiment, the grit member 124 is a grating having a plurality of intersecting walls that define a grid. The openings in the grid allow direct and debris that is removed from a cleaning tool to settle to the bottom of the bucket 132 and avoid or reduce the risk of contaminating cleaning tools when they are positioned within the interior of the bucket.

The tray member 116 is coupled to and offset from the trolley 102 and allows the user to store and transport cleaning tools and/or supplies on the trolley 102. The tray member 116 may include legs 150, 152. The tray member 116 may be removably coupled to the trolley 102. The tray member 116 may include at least one recessed area 118A adapted to have storage regions for cleaning tools, such as, but not limited to, sponges, cloths, rags, brushes, and cleaning products. The tray member may include a plurality of recess areas 118A. In one or more embodiments, the recess areas 118A may have a plurality of holes 154 to allow fluids to drain therethrough. In one or more embodiments, the tray member 116 may have one or more openings 120 sized to receive the handles of cleaning tools.

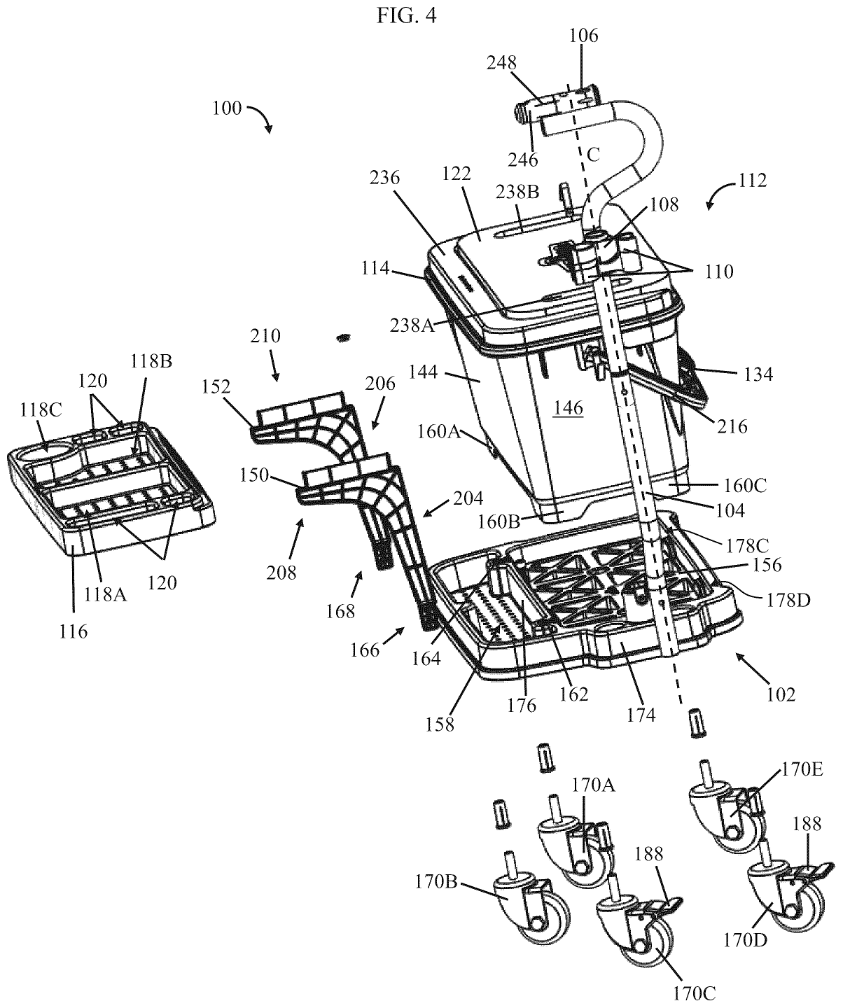

Referring to FIG. 4, the trolley 102 may include a first area 156. The first area 156 is sized to receive the bucket 132. In some embodiments, the first area 156 may include a grid pattern with openings formed therethrough to allow fluids to drain through the bottom of the trolley 102. The bucket 132 may include at least one fin or foot 160A extending from a bottom corner of the bucket 132. The at least one foot 160A is configured to slide into a corresponding at least one slot 178A formed in the first area 156.

In an embodiment, the trolley 102 includes a second area 158 adjacent to the first area 156. The tray member 116 may be coupled to the second area 158 of the trolley 102. The second area 158 may include at least one cavity to receive a distal end of at least one leg of the tray member 116. In some embodiments, the second area includes two cavities 162, 164 configured to receive a distal end 166, 168 of the legs 150, 152 of the tray member 116. In some embodiments, the second area 158 may further include a plurality of holes to allow fluids drain therethrough. The second area 158 may be adapted to be a storage region for cleaning tools, such as, but not limited to, sponges, cloths, rags, brushes, and cleaning products. The tray member 116 and second area 158 cooperate to allow the user to organize and store their tools when not in use and avoid placing the tools on the ground. The plurality of holes in the tray member 116 and the second area 158 further facilitates improved air drying of the tools stored therein.

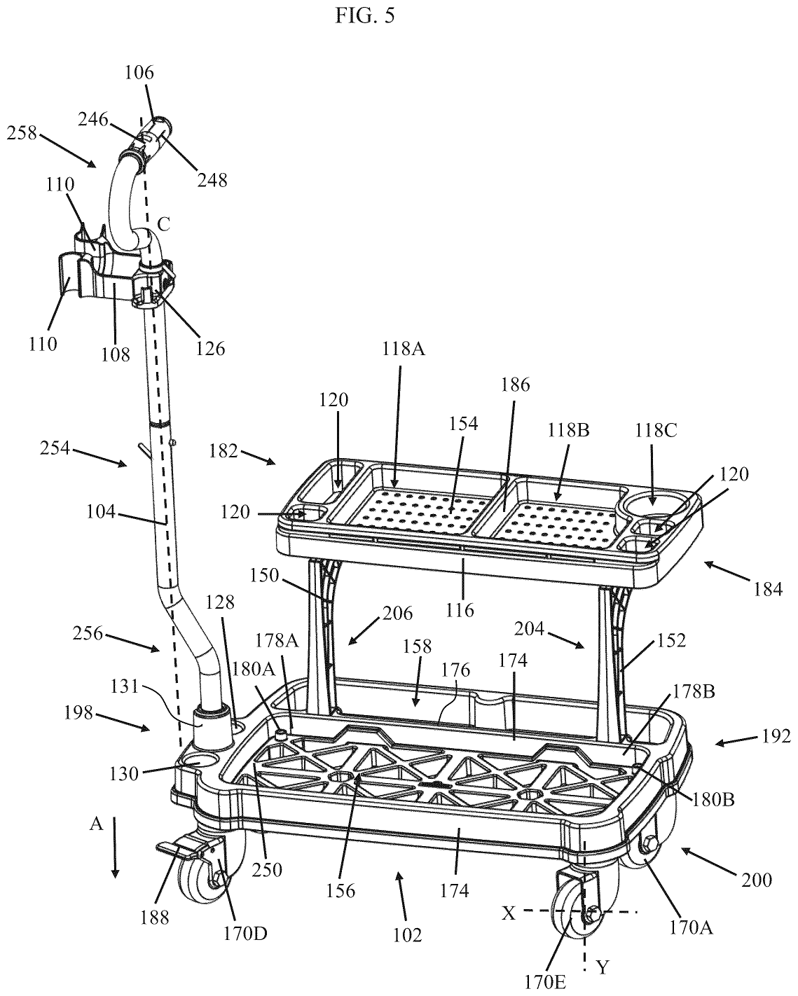

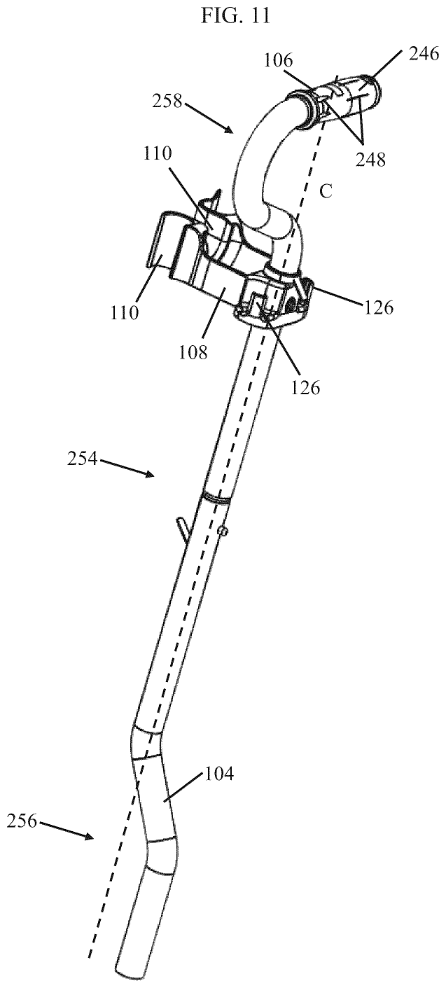

As discussed further herein with respect to FIG. 11, the trolley 102 may include a feature 131 (FIG. 5) sized to receive the pole 104. It should be appreciated that while embodiments herein illustrate the pole 104 as having a curved, s-shaped, or off-set portion, this is for example purposes and the claims should not be so limited. In other embodiments, the pole 104 is straight between the trolley and the upper section 258. In still further embodiments, the handle 106 connects directly to the pole 104 and is generally perpendicular to the longitudinal axis of the pole.

In some embodiments, the trolley 102 may further include a plurality of wheels 170A. The plurality of wheels 170A depend from an undersurface 172 of the trolley. The plurality of wheels 170A allow the cleaning system 100 to be easily moved across a surface, such as the ground or a driveway for example. In an embodiment, the plurality of wheels 170A rotate about two axes X, Y to allow freedom of movement of the cleaning system 100. The user may manipulate the cleaning system 100 and move the cleaning system 100 to a desired location via the pole 104. In some embodiments, the trolley 102 may include 5 wheels 170A, 170B, 170C, 170D, 170E. In this embodiment, three wheels (170A-170C) may depend from the second area 158 and two wheels (170D, 170E) may depend from the first area 156. Alternatively, two wheels may depend from the first area 156 and the second area 158 with a fifth wheel positioned substantially center from the undersurface 172 of the trolley 102, or three wheels may depend from the first area 156 and two wheels may depend from the second area 158. In some embodiments, the trolley 102 may include three or four wheels. Those skilled in the art will appreciate that any number of wheels 170A may be employed without departing from the scope of the present disclosure.

Referring to FIGS. 5-7, the first area 156 and the second area 158 may be recessed within a frame 174 of the trolley 102. The first area 156 may be separated from the second area 158 by a wall 176. The first area 156 of the trolley 102 may further include at least one slot 178A configured to receive the at least one foot 160A of the bucket 132. In the illustrated, non-limiting embodiment, the first area 156 includes four slots 178A, 178B, 178C, 178D configured to receive the feet 160A, 160B, 160C, 160D of the bucket 132. The slots 178A-178D are positioned in corners of the first area 156 and formed on the frame 174 and the wall 176. In some embodiments, the first area 156 may further include four mating pins, pine 180A, 180B and two pins on an opposite side of the first area 156 (not shown), for aligning the bucket 132 in the first area 156 as the bucket 132 is placed on the trolley 102. The mating pins 180A-180D may be positioned in corners of the first area 156 on a bottom surface 250 of the first area 156. The bucket 132 includes corresponding mating pins 242A, 242B, 242C, 242D, described below, that mate with the mating pins 180A-180D of the first area 156.

As described above, the bracket 108 includes clips 110 configured to hold cleaning tools and a hose or hose sprayer. As shown in FIG. 5, the bracket 108 may include two clips 110. In an embodiment, the clips 110 extend from the pole 104 away from the trolley 102 to provide clearance for cleaning tools, hose, or hose spray to be stored on the cleaning system 100 and does not hit or otherwise interfere with the trolley 102, bucket assembly 112, or tray member 116. The bracket 108 may include two hooks 126 disposed on opposing sides of the bracket 108. The pole 104 be substantially straight along the central axis C. In some embodiments, the pole 104 has a center section 254 that is substantially straight along the central axis C with a lower section 256 offset from the central axis C and an upper section 258 that is substantially u-shaped. The upper section 258 may be concaved away from the central axis C. The bracket 108 is coupled to the center section 254 of the pole 4.

As shown in FIG. 5, in the illustrated, non-limiting embodiment, the openings 120 of the tray member 116 may be positioned on a first end 182 and a second end 184 of the tray member 116 with the recessed area(s) 118 being disposed therebetween. In the illustrated, non-limiting example, the tray member 116 includes two openings on the first end 182 and the second end 184 of the tray member 116. In an embodiment, the openings 120 may have substantially the same size and shape. The openings 120 may have a rectangular shape, substantially rectangular shape, a square shape, or a substantially square shape. In some embodiments, one of the openings 120 may be dimensioned larger than the other openings 120 to receive larger cleaning tool handles. The tray member 116 may include one recessed area 118A spanning the distance between the openings 120. In some embodiments, the tray member 116 may include a first recessed area 118A and a second recessed area 118B separated by a divider 186. The first and the second recessed areas 118A, 118B may have substantially the same size and shape. The first and the second recessed areas 118A, 118B may have a rectangular shape, substantially rectangular shape, a square shape, a substantially square shape, an ovoid shape, or a substantially ovoid shape. Alternatively, the first recessed area 118A may be dimensioned larger than the second recessed area 118B or the second recessed area 118B may be dimensioned larger than the first recessed area 118A. The tray member 116 may include a third recessed area 118C positioned on the first end 182 of the tray member 116. The third recessed area 118C may have a circular shape, substantially circular, oval, or substantially oval shape and is dimensioned smaller than the first and second recessed areas 118A, 118B.

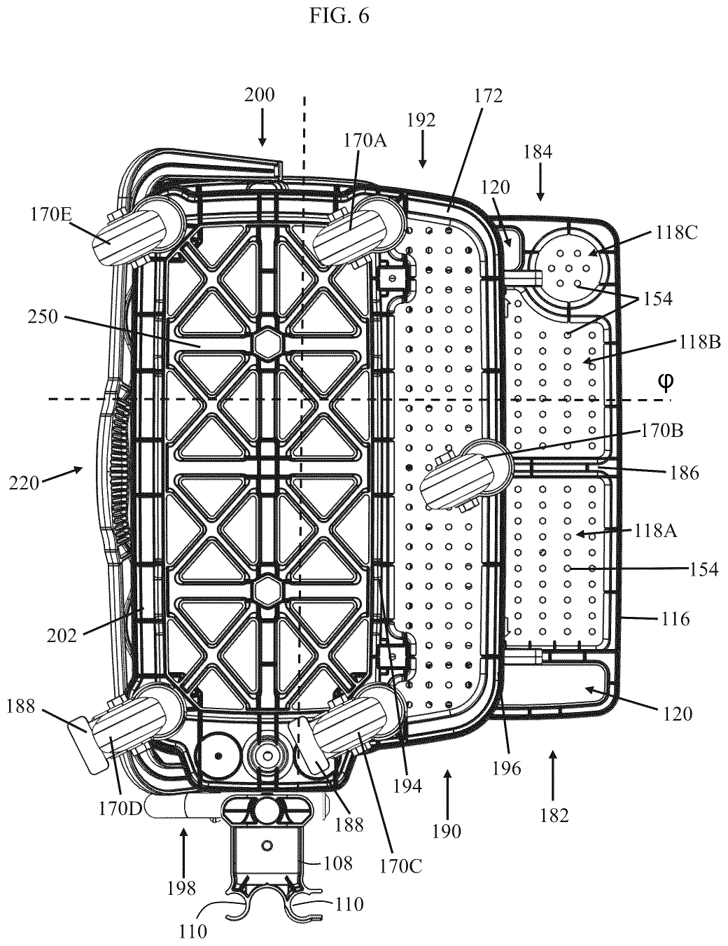

In an embodiment, to reduce the risk of the cleaning system 100 from moving when it is placed in a desired location, one or more of the plurality of wheels 170A may include a lock 188. The user may engage the lock 188 by pressing the lock in a downward direction A (FIG. 5) such that the lock 188 engages the wheel 170A and prevents rotation thereof. As described above, the trolley 102 may include five wheels 170A-170E. As shown in FIG. 6, three wheels 170A-170C depend from the second area 158 and two wheels 170D,170E depend from the first area 156. The first and second wheel 170A, 170B may be secured to a first end 190 and a second end 192 of the second area 158, respectively, at an inside end 194 of the second area 158. The third wheel 170C may be secured to an outside end 196 of the second area 158 and positioned substantially center on the outside end 196. The fourth and fifth wheel 170D, 170E may be secured to a first end 198 and the second end 200 of the first area 156, respectively, at an outside end 202 of the first area 156. The positon of the wheels 170A-170E allow for improved balance and movability of the cleaning system 100. As water/cleaning solution is added to the bucket 132 and cleaning tools are stored on the cleaning system, the weight distribution and center of gravity of the cleaning system 100 changes. The positions of the wheels 170A-E prevent the cleaning system 100 from tipping and/or becoming unbalanced despite the change in weight distribution.

As shown in FIG. 6, the length of the bucket 132, trolley 102, and tray member 116 is defined by a longitudinal axis 2, which runs the long-wise distance of the cleaning system, for example the distance of (e.g., generally parallel to) the direction of the wall 176, inside end 194 and outside ends 196, 202. The longitudinal axis λ is transverse (e.g., generally perpendicular to) to the first ends 182, 190, 198 and the second ends 184, 192, 200. The width of the bucket 132, trolley 102, and tray member 116 is defined by a latitudinal axis o, which runs the short-wise distance of the cleaning system 100, for example the distance of (e.g. generally parallel) the direction of the first ends 182, 190, 198 and the second ends 184, 192, 200. The latitudinal axis q is transverse to (e.g., perpendicular to) the wall 176, inside end 194, and outside ends 196, 202. In some embodiments, the first area 156 and the second area 158 may have substantially the same length along the longitudinal axis 2. In some embodiments, the first area 156 may have a width along the latitudinal axis q dimensioned larger than a length of the second area along the latitudinal axis q.

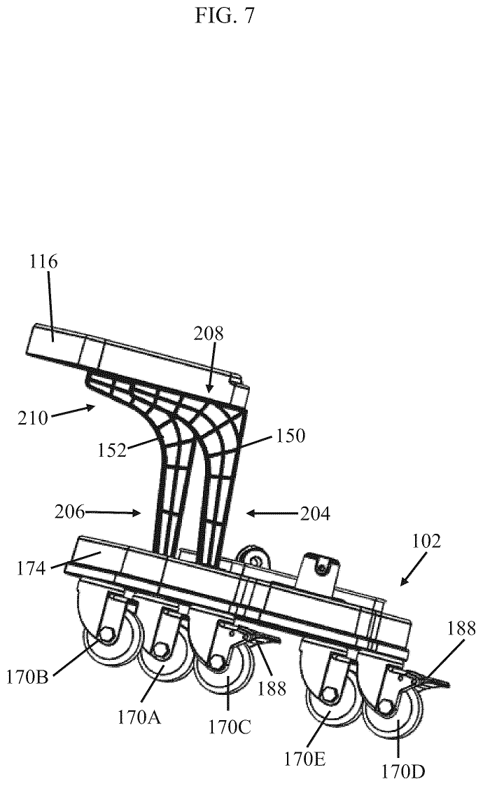

As further shown in FIG. 6, in an embodiment the tray member 116 is offset from the trolley 102 such that it overhangs or extends beyond the second area 158. The legs 150, 152 of the tray member 116 are substantially L shaped. The cavities 162, 164 of the second area 158 are positioned along the inside end 194 of the second area 158 and may abut the wall 176 separating the first area 156 and the second area 158 (FIG. 5). As described above, the cavities 162, 164 receive the distal end 166, 168 of the legs 150, 152. Referring to FIG. 7, in an embodiment the legs 150, 152 have a first portion 204, 206, respectively, that project up, substantially perpendicular to the trolley 102, and a second portion 208, 210 of the legs 150, 152 extend from the first portion 204, 206, respectively, away from the trolley 102. The tray member 116 is attached to and rests on the second portion 208, 210 of the legs 150, 152. The orientation of the legs 150, 152 (i.e., extending away from the trolley 102) allows for the tray member 116 to be offset from the trolley 102. In some embodiments, the second portion 208, 210 may have a length dimensioned substantially the same as the width of the tray member 116. In some embodiments, the second portion 208, 210 may have a length dimensioned smaller than the width of the tray member 116. In some embodiments, the first portion 204, 206 and the second portion 208, 210 may be dimensioned the same length. In yet other embodiments, the first portion 204, 206 or the second portion 208, 210 may be dimensioned smaller than the other.

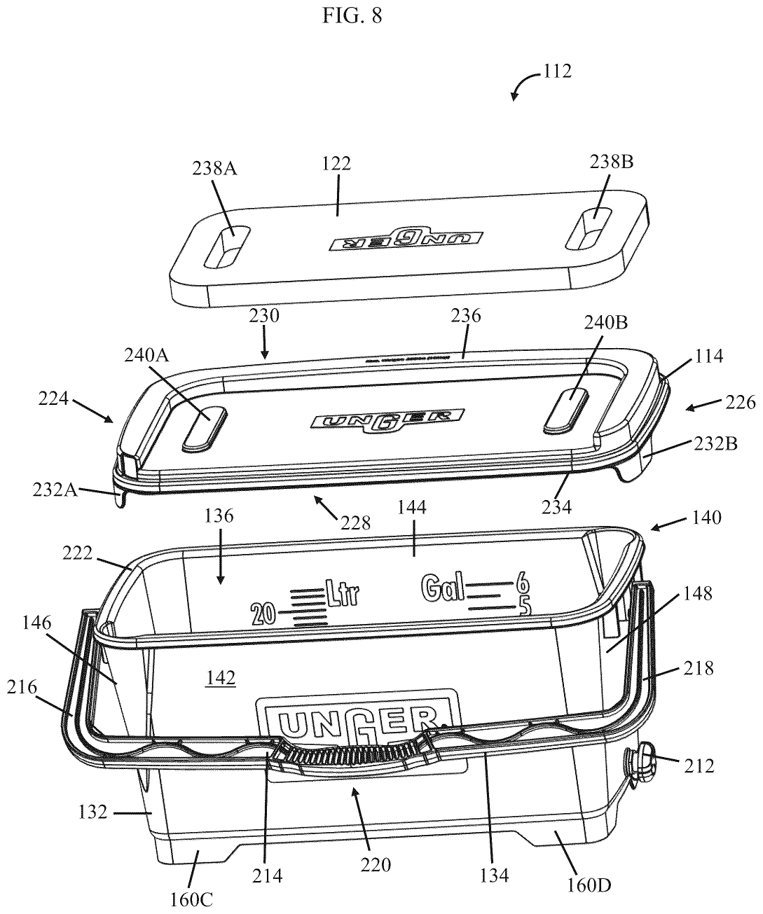

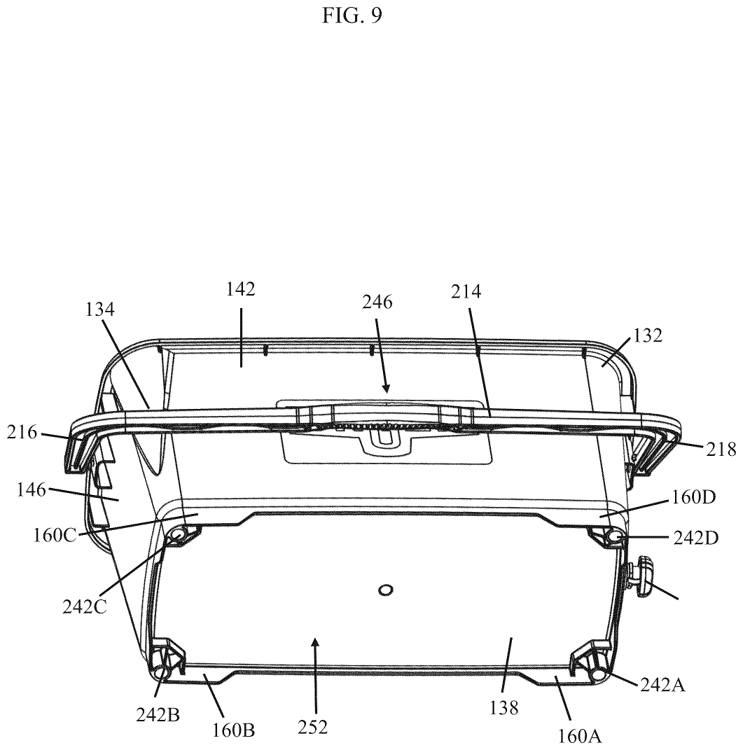

Referring to FIGS. 8 and 9, advantageously, the cleaning system 100 includes the bucket assembly 112. As described above, the bucket assembly 112 includes the bucket 132, the cover 114, the kneeling pad 122, and the handle 134.

The bucket 132 has plurality of walls that define the interior area 136, including: the first end wall 142, the second end wall 144, the first side wall 146, and the second side wall 148. The longitudinal axis 2 defines the length of the bucket 132, running the distance of (e.g., generally parallel to) the direction of the first end wall 142 and the second end wall 144 and transverse (e.g., generally perpendicular to) to the direction of the first side wall 146 and the second side wall 148. The latitudinal axis q defines the width of the bucket 132, running the distance of (e.g., generally parallel to) the direction of the first side wall 146 and the second side wall 148 and transverse (e.g., generally perpendicular to) to the direction of the first end wall 142 and the second end wall 144. The interior area 136 is further defined by the base 138 and the open top 140, along with the plurality of walls. The interior area 136 is sized to receive cleaning tool(s) and cleaning fluid. The first end wall 142 and the second end wall 144 are opposite one another, connected by the first side wall 146 and the second side wall 148, the first side wall 146 and the second side wall 148 being opposite one another. In some embodiments, the bucket 132 may include a drain plug 212. The drain plug 212 may be formed in any of the walls. By way of example, the drain plug 212 may be formed in the second end wall 144, as shown in FIG. 8. The drain plug 212 is removabl coupled to the second end wall 144 and allows fluid and collected debris to be drained from the bucket 132, as well as to increase the ease of cleaning the cart.

In some embodiments, the base 138 may slope toward one of the walls, for example first side wall 146. Those skilled in the art will appreciate that the base 138 may slope to any of the walls and may slope towards a pair of the walls without departing from the scope of the present disclosure. By way of example, the base 138 may be sloped towards the wall where the drain plug 212 is located. In this way, the base 138 can capture or collect any fluid or dirt for easy cleaning.

The bucket assembly 112 further includes the handle 134 allowing the bucket 132 to be lifted or moved by the user. The handle 134 may be pivotally mounted to the bucket 132 such that it may be positioned in various ways relative to the bucket 132 according to the user and may be moved from a non-use position (see FIG. 2) to a carrying position (not shown) where the handle projects vertically upward, above the open top 140 of the bucket 132. The handle 134 may be rotated about the longitudinal axis 2. The range of rotation of the handle 134 enables the handle 134 to move from the first side wall 146 to the second side wall 148 in a direction along the latitudinal axis q.

The handle 134 includes a center portion 214 with a pair of opposing arms, the first arm 216 and the second arm 218. The center portion 214 and the first arm 216 and the second arm 218 form a substantially u-shaped member. A grip area 220 may be formed substantially center in the center portion 214. The grip area 220 may have an arched shape and a plurality of grooves to provide improved graspability of the handle 134. The grip area 220 may rotate 250 degrees, 200 degrees, 180 degrees, 120 degrees, 90 degrees, or 50 degrees, for example.

The cover 114 is sized to engage the plurality of walls 142, 144, 146, 148 on the top edge 222. The cover 114 may be dimensioned substantially the same as the open top 140 of the bucket 132. The cover 114 has a first side 224, a second side 226, a first end 228, and a second end 230. The cover 114 may further include at least one tab 232A extending from a bottom surface 234 of the cover 114 and adapted to engage the top edge 222 and a portion of the plurality of walls. In the illustrated, non-limiting embodiment, the cover 114 includes two tabs 232A, 232B extending a first side 224 and a second side 226. Those skilled in the art will appreciate that the cover 114 may include any number of tabs 232A positioned on the first side 224, the second side 226, the first end 228, and/or the second end 230 without departing from the scope of the present disclosure.

The cover 114 may further include a ridge 236 spanning from the first side 224, along the second end 230, to the second side 226. The ridge 236 provides a backstop for the kneeling pad 122 and inhibits movement of the kneeling pad 122 to maintain the kneeling pad 122 on top of the cover 114. The kneeling pad 122 is sized to rest on top of the cover 114 and abut the ridge 236. In some embodiments, the kneeling pad 122 may include openings 238A, 238B located on opposing sides of the kneeling pad 122. In this embodiment, the cover 114 may include raised portions 240A, 240B that align with the openings 238A, 238B when the kneeling pad 122 is placed on top of the cover 114 and extends into the openings 238A, 238B. The openings 238A, 238B allow the user to easily pick up the kneeling pad, additionally, the combination of the openings 238A, 238B and raised portions 240A, 240B inhibit movement of the kneeling pad 122 while on top of the cover 114. The kneeling pad, advantageously, reduces strain on the user's joints when cleaning low areas of the vehicle. Additionally, the cover 114 and bucket 132 have sufficient rigidity to allow the user to sit on top of the cover 114, while attached to the bucket 132, while cleaning or drying low areas of the vehicle. In an embodiment, the trolley, bucket, and cover are configures to support a user with a weight of 225 lb-250 lb (102 kg-114 kg) when sitting on the cover.

The kneeling pad 122 being made from a suitable soft material, for example a closed or open cell foam, such that the user may comfortably kneel on the kneeling pad 122 for a duration of time while cleaning a low-clearance area such as the tires of a vehicle. The bucket 132, handle 134, and cover 114 can be formed of any material having sufficient strength, rigidity, and resiliency. In some embodiments, bucket 132, handle 134, and cover 114 are formed of polypropylene (PP).

Referring to FIG. 9, the bucket 132 includes four feet 160A-D extending from corners defined by the first side wall 146, the second side wall 148, the first end wall 142, and the second end wall 144. The feet 160A-160D are configured to slide into the corresponding slots 178A-178D formed in the first area 156 of the trolley 102. The bucket 132 may also rest on the feet 160A-160D when the user removes the bucket 132 from the first area 156 and places the bucket 132 on another surface, for example the ground. As described above, in some embodiments, the bucket 132 may further include mating pins 242A-242D configured to mate with the mating pins 180A-180D of the first area 156. The mating pins 242A-242D of the bucket 132 are positioned in corners of the bucket 132 on a bottom surface 252 of the base 138. In an embodiment, the feet 160A-160D are positioned adjacent to the mating pins 242A-242D and extend from the bucket 132 in front of the mating pins 242A-242D. As the user places the bucket 132 on the trolley 102, the feet 160A-160D engage the slots 178A-178D and the mating pins 180A-180D, 242A-242D engage with each other to align the bucket 132 in the first area 156. In some embodiments, mating pins 242A-242D and the feet 160A-160D are dimensioned to have substantially the same length, the length being the distance the mating pins 242A-242D and feet 160A-160D extend from the bucket 132. In some embodiments, the mating pins 242A-242D have a length dimensioned shorter than the length of the feet 160A-160D.

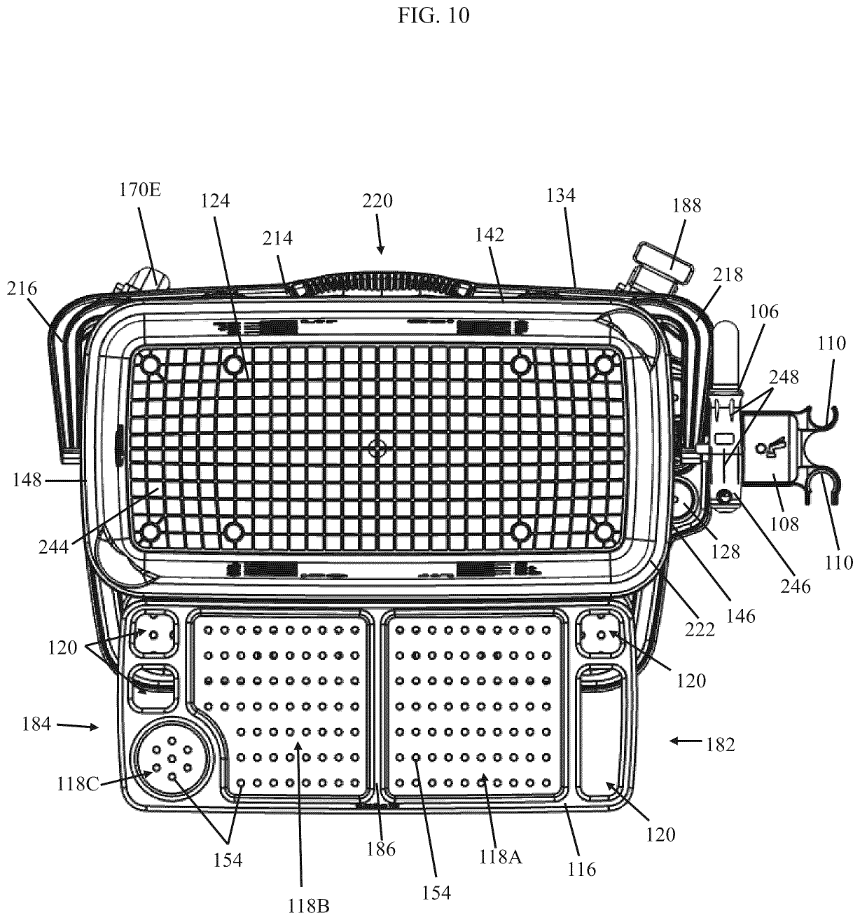

Referring to FIG. 10, the bucket 132 may further include the grit member 124, as shown in FIG. 9. The grit member 124 is dimensioned substantially the same as the lower portion of bucket 132 such that it may be placed in the interior area 136, on the base 138 of the bucket 132. The grit member 124 is configured to agitate the fibers of a cleaning tool, for example, but not limited to, a mop pad of a mop or a brush when the cleaning tool is moved over the grit member. The grit member 124 has a plurality of holes 244 throughout the surface area of the grit member 124 to allow fluid and debris to flow therethrough. The plurality of holes 244 may be square shaped, circular shaped, or a combination thereof. The grit member 124 prevents or reduces the risk of a cleaning tool inserted into the interior area 136 from contacting debris that may settle to the bottom of the bucket 132. The plurality of holes 244 are dimensioned large enough such that debris may flow through the hole and settle to the bottom of the bucket 132 and are dimensioned small enough such that the debris is influenced to remain at the bottom and the cleaning tool cannot be inserted into an opening whereby it may re-contact with debris settled at the bottom. It should be appreciated that this prevents or reduces the risk of debris being reintroduced into or contaminating the cleaning tool. The grit member 124, thus advantageously, avoids debris caught in a cleaning tool scratching the surface being cleaned, for example an exterior surface of a vehicle, by trapping dirt and debris at the bottom of bucket. The grit member 124 can be formed of any material having suitable strength, rigidity, and resiliency, for example the grit member 124 may be formed of polypropylene (PP).

A non-limited example method of operation of the cleaning system 100 includes a scrub brush used with the bucket 132 for cleaning and recharging a scrub pad attached to the scrub brush. The user initiates the cleaning of a surface (e.g the exterior of a vehicle) by placing cleaning fluid in the interior area 136. The scrub pad is wetted by placing the scrub brush in the interior area 136. As the user wipes the scrub pad across the surface, dirt and debris from the surface will accumulate on the scrub pad. Periodically, the user may desire to clean the scrub pad and recharge the scrub pad with new cleaning solution. The user lifts the scrub brush from the surface being cleaned and inserts the scrub brush into the interior area 136 placing the dirty scrub pad into contact with the cleaning fluid within the interior area 136. It should be appreciated that the placing scrub pad in the cleaning fluid will cause dirt to be released from the fibers of the scrub pad. The user may also optionally place the scrub pad against the grit member 124 and rub the scrub pad over the plurality of holes 244, which agitates the fibers of the scrub pad further loosening dirt or debris. The grit member 124 allows the user to loosen and release more dirt and debris from the scrub pad than placing the scrub pad in the cleaning fluid alone.

In some embodiments, the bucket 132 may be configured for use with a divider (not shown), which can be installed and removed from the bucket 132. When installed, the divider separates the bucket 132 into a first and a second reservoirs and mitigates leakage of water or cleaning solution between the reservoirs. Advantageously, the bucket 132 and divider provide a biased multi-surface seal that mitigates and, in many instances prevents leakage of fluids between first and second reservoirs. In this embodiment, the cleaning tool can be wetted and recharged in the first or second reservoir and debris may be removed from the cleaning tool in the second or first reservoir.

In some embodiments, the handle 134 may be lockable. In allowing the handle to be locked in an upright position, the amount of bending the user performs while picking up and moving the bucket during use is reduced. The user may desire to engage the handle 134 to arrange the handle 134 in a desired position. For example, the handle 134 may be positioned in line with the longitudinal axis λ. The positioning of the handle 134 in line with the longitudinal axis λ is the carrying position, or an up-right or vertical position. The handle 134 may be positioned off of the longitudinal axis λ, in a non-carrying position. For instance, −60 degrees, −50 degrees, −40 degrees, −30 degrees, −20 degrees, −15 degrees, −10 degrees, −5 degrees, 5 degrees, 10 degrees, 15 degrees, 20 degrees, 30 degrees, 40 degrees, 50 degrees, 60 degrees, away from the longitudinal axis λ. The handle 134 is rotated toward the second side wall 148 when disposed at a negative degree from the longitudinal axis λ. The handle 134 is rotated toward the first side wall 146 when disposed at a positive degree from the longitudinal axis λ. The handle 134 may therefore be rotated and locked at −60 degrees, −50 degrees, −40 degrees, −30 degrees, −20 degrees, −15 degrees, −10 degrees, −5 degrees, 0 degrees, 5 degrees, 10 degrees, 15 degrees, 20 degrees, 30 degrees, 40 degrees, 50 degrees, 60 degrees, forward or away from the longitudinal axis, for example.

The pair of opposing arms 216, 218 each have a moveable pin with a leg member. The first end wall 142 and second end wall 144 have a slot. The leg member may be positioned in the slot. The pin is rotational and slidably coupled in the slot. The handle may be translated between a first position where the handle 134 is free to rotate, and a second position where the handle 134 is locked in a desired position, such as the vertical position for example. The leg member of the pin may be positioned into the slot when the handle is fixed in a desired position.

Referring to FIG. 11, an embodiment of the handle 106 of the pole 104 is shown that includes a gripping feature 246 mounted or co-molded to the handle 106. In some embodiments, the pole 104 may be substantially straight along the central axis C. As described above, in some embodiments, the pole 104 has a center section 254 that is substantially straight along the central axis C with a lower section 256 offset from the central axis C and an upper section 258 that is substantially u-shaped. The upper section 258 may be concaved away from the central axis C. The bracket 108 is coupled to the center section 254 of the pole 4. The lower section 256 offsets the pole 104 from the trolley 102 providing clearance for a user to place the bucket 132 in the first area 156, access the bucket 132 while it is stored in the first area 156, and store and access cleaning tools on the tray member 116. The curved shape of the upper section 258 provides improved leverage and controllability of the cleaning system as the user moves the cleaning system. The handle 106 may be positioned on the upper section 258 of the pole 104.

The gripping feature 246 of the handle 106 may be formed on an outer surface of the handle 106 and wraps about the entire periphery of the handle 106. The gripping feature 246 may be positioned and designed to facilitate a user's grasp about the handle 106. For example, the gripping feature 246 may include at least one elongate rib 248 extending generally parallel to a longitudinal axis Z of the handle 106. In some embodiments, the gripping feature 246 may include a plurality of elongate ribs 248. In this embodiment the plurality of elongate ribs 248 are spaced substantially equidistant about a periphery of the handle 106. A surface of the gripping feature 246 in between the plurality of elongate ribs 248 may be a substantially smooth surface. In some embodiments, the surface of the gripping feature 246 in between the plurality of elongate ribs 248 may be a textured surface, for example a series of bumps or ridges. The textured surface may provide improved graspability of the handle 106 be increasing the friction points between the user's hand and the gripping feature 246.

In some embodiments, the entire surface of the gripping feature 246 may include a substantially smooth surface. Alternatively, the entire surface of the gripping feature 246 may include the textured surface. In some embodiments, the gripping feature 246 may include at least one groove (not pictured) arranged within a plane substantially perpendicular to the longitudinal axis Z, such that the groove wraps about at least a portion of the gripping feature 246, and in some embodiments an entirety, of the periphery of the gripping feature 246. It should be appreciated that the gripping features illustrated and described herein are intended as an example only and that a gripping feature having any suitable configuration is within the scope of the disclosure. Furthermore, embodiments where the handle 106 does not include any gripping features are also within the scope of the disclosure.

Embodiments of the present disclosure provide advantages in assisting a user in the cleaning of a vehicle by providing an organization structure that allows for all or substantially all of the tools used in the cleaning process to be kept at hand and protected from dirt and other contaminants. While embodiments herein may reference to the cleaning of a particular vehicle, such as an automobile, this is for example purposes and the claims should not be so limited. In other embodiments the cleaning system may be used to assist in the cleaning of other vehicles such as motorcycles, bicycles, mopeds, recreational vehicles, boats, jet-skis, helicopters, airplanes, and the like. Further, the cleaning system may be used to assist in cleaning other non-vehicle articles, such as house siding, decks, patios, landscaping, sheds, or outdoor furniture for example.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It should also be noted that the terms “first”, “second”, “third”, “upper”, “lower”, and the like may be used herein to modify various elements. These modifiers do not imply a spatial, sequential, or hierarchical order to the modified elements unless specifically stated.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of +8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments described herein.

While the disclosure is provided in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that the exemplary embodiment(s) may include only some of the described exemplary aspects. Accordingly, the disclosure is not to be seen as limited by the foregoing description, but is only limited by the scope of the appended claims.

What is claimed is:

1. A cleaning system comprising:
a trolley, the trolley comprising:
a first area,
a second area adjacent to the first area,
a plurality of wheels depending from an undersurface of the trolley;
a tray member extending from the trolley;
a bucket assembly selectively stored on the trolley; and
a pole extending from a first end of the trolley, having a handle extending therefrom.

2. A cleaning system of claim 1, wherein the first area and the second area are recessed within a frame of the trolley and the first area is separated by the second area by a wall.

3. A cleaning system of claim 2, the second area further comprising at least one cavity configured to receive at least one leg of the tray member, wherein the at least one cavity is adjacent to the wall.

4. A cleaning system of claim 3, wherein the second area comprises a first cavity positioned at the first end of the trolley and adjacent to the wall and a second cavity positioned at a second end of the trolley and adjacent to the wall.

5. A cleaning system of claim 1, wherein the first area includes a bottom surface having a grid pattern and the second area includes a bottom surface having a plurality of holes.

6. A cleaning system of claim 2, the first area further comprising at least one slot formed in a corner of the first area on the frame or the wall, wherein the at least one slot is configured to engage the bucket assembly.

7. A cleaning system of claim 6, wherein the first area comprises four slots formed in four corners of the first area.

8. A cleaning system of claim 1, the first area further comprising at least one mating pin extending from a bottom surface of the first area in a corner of the first area to align the bucket assembly in the first area.

9. A cleaning system of claim 8, wherein the first area comprises four mating pins extending from the bottom surface in four corners of the first area.

10. A cleaning system of claim 1, wherein at least one wheel of the plurality of wheels includes a lock configured to engage the at least one wheel and prevent rotation thereof, thereby inhibiting movement of the trolley.

11. A cleaning system of claim 1, the bucket assembly further comprising:
a bucket having a base, an open top, and a plurality of walls defining an interior area;
a bucket handle having a center portion with a pair of opposing arms, the handle rotatably coupled to the bucket;
a grit member removably positioned within the interior area;
a cover configured to engage the plurality of walls on a top edge; and
a kneeling pad selectively stored on the cover.

12. A cleaning system of claim 11, the bucket further comprising:
at least one foot extending from a bottom end of a corner defined by two walls of the plurality of walls;
at least one mating pin extending from a bottom surface of the base in a corner of the first area, and
wherein the at least one mating pin of the bucket is configured to mate with the at least one mating pin of the first area.

13. A cleaning system of claim 12, wherein the bucket comprises four feet extending from four corners of the bucket and four mating pins extend from the bottom surface of the base in the four corners of the bucket.

14. A cleaning system of claim 11, the cover further comprising:
a first side, a second side opposing the first side, a first end disposed between the first side and second side, and a second end opposing the first end;
a first tab and a second tab, the first tab and the second tab opposing one another; and
a ridge formed along the first side, second end, and second side of the cover.

15. A cleaning system of claim 14, wherein the kneeling pad is dimensioned to fit in an area defined by the ridge and abut the ridge.

16. A cleaning system of claim 11, wherein the grit member is substantially planar and includes a plurality of holes extending therethrough.

17. A cleaning system of claim 1, the tray member further comprising:
at least one recessed area having a plurality of holes extending therethrough;
at least one opening; and
at least one leg having a first portion coupled to the second area of the trolley and a second portion coupled to the tray member.

18. A cleaning system of claim 17, wherein the first portion of the at least one leg is inserted into at least one cavity of the second area and the second portion of the at least one leg is oriented away from the trolley, thereby offsetting the tray member from the trolley.

19. A cleaning system of claim 1, further comprising a bracket coupled to the pole, the bracket comprising at least one clip and at least one hook.

20. A method of using a cleaning system, the method comprising:
filling an interior area of a bucket with a cleaning fluid, the bucket comprising:
a base, an open top, and a plurality of walls defining the interior area, a handle having a center portion with a pair of opposing arms, the handle rotatably coupled to the bucket, and a grit member removably positioned in the interior area;
inserting a cleaning tool in the interior area to wet the cleaning tool;
cleaning a surface with the cleaning tool;
reinserting the cleaning tool in the interior area;
scrubbing the cleaning tool against the grit member to remove contaminates from the cleaning tool; and
removing the cleaning tool from the interior area.
